(19) United States
(12) Patent Application Publication
(10) Pub. No.: US 2015/0326796 A1
(43) Pub. Date: Nov. 12, 2015

(54) BINAL SYNCHRONIZED LENS SYSTEM

(71) Applicant: Tobias Oggenfuss, Los Angeles, CA (US)

(72) Inventor: Tobias Oggenfuss, Los Angeles, CA (US)

(21) Appl. No.: 14/273,734

(22) Filed: May 9, 2014

(51) Int. Cl. H04N 5/265; H04N 5/374; H04N 5/225; H04N 5/232

(52) U.S. Cl. CPC H04N 5/265; H04N 5/23222; H04N 5/374; H04N 5/2254; H04N 5/2253

(57) ABSTRACT

A duel lens camera for optimizing images including: a first lens, where the first lens includes a CMOS sensor; a second lens, where the second lens includes a spinning cylinder and said spinning cylinder spins the second lens to capture lighting values; a first CPU, where the first CPU processes an image captured by the first lens; a second CPU, where the second CPU process an image captured by the second lens; and a image layering processor, where the image layering processor weaves the two images together where the cylinder image becomes the platform image that applies balance and proportional light onto the image.

### BACKGROUND OF THE INVENTION

1. Field of Invention

The present invention relates to a two-part lens system that is implemented to optimize exposure during photography.

2. Description of Related Art

Photographs are an art and science that relates to the reproduction of images in a fixed medium. Photographs have traditionally involved a chemical and film process however, more recent technology relates to digital imaging through the use of digital photography. Digital photography uses image sensors to capture images for storage electronically in a digital form. The initial sensors of digital photography were charge-coupled devices (CCDs) that captured images converting the light into electrons for storage in a digital format. More recent cameras have implemented CMOS image sensors, which are less expensive and are more effective in capturing images for storage the digital imaging within a digital camera. CMOS sensors have several transistors and these transistors help to capture the pixels related to the images being captured by the camera. CMOS is an acronym for complementary metal-oxide semiconductor. These conductors consume less power and are cheaper to fabricate than the CCDs that were formally used in digital cameras. In addition to the sensors used within the cameras there are various other controls related to the capturing of images such as the focus, aperture, shutter speed, ISO speed and any autofocusing systems. Other factors that may control the image capture will include focal length of the actual length and any filters that are used on the lens. Typically in low light situations a flash is needed to provide sufficient light for the image to be captured by the camera. Further certain low light situations require tripods and in terms of ISO speeds these speeds may typically need to be high in a low light situation. Further the shutter speed may be slower in order to also capture the image due to low lighting. These various factors as a consequence make low light situations more difficult to capture suitable images and further require knowledge of the various factors related to image capturing such as the shutter speed and ISO speed. As a consequence, it would be advantageous to have a system that relied upon a more automated process and to capture low light images.

### SUMMARY OF THE INVENTION

The present invention relates to a duel lens camera for optimizing images comprising: a first lens, where the first lens includes a CMOS sensor; a second lens, where the second lens includes a spinning cylinder and said spinning cylinder spins the second lens to capture lighting values; a first CPU, where the first CPU processes an image captured by the first lens; a second CPU, where the second CPU process an image captured by the second lens; and a image layering processor, where the image layering processor weaves the two images together where the cylinder image becomes the platform image that applies balance and proportional light onto the image.

### BRIEF DESCRIPTION OF DRAWINGS

FIG. 1 depicts a front view of dual lenses used in a synchronized lens system of the present invention.

FIG. 2 depicts a top view of the dual lenses used in the synchronized lens system according to the present invention.

### DETAILED DESCRIPTION

The present invention relates to a dual lens synchronized system that incorporates the use of two lenses to capture images within a digital camera. The present invention addresses low lighting situations and therefore eliminates the need for flash, tripod and high ISO values. Further the camera may be handheld and the user may create balanced lighting with each image taken due to the processing provided by the dual lenses with the present invention. In general these lenses are placed side by side within the camera and function in two different ways in order to create digital images. The first lens is a typical CMOS style lens while the second one is a cylinder that spins in order to map light values provided in the image. These light values are spread evenly over the frame and processed with the image provided by the traditional CMOS lens to create an optimal clear digital image.

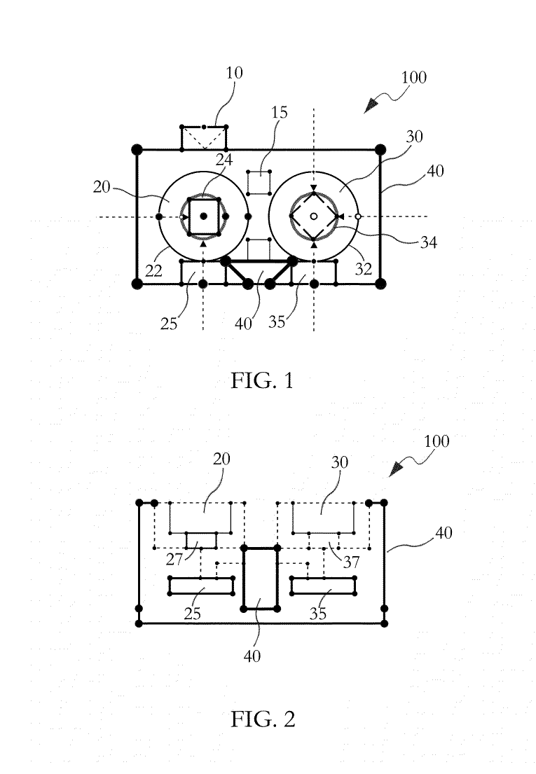

In reference to FIG. 1, a front view of a Camera 100 in accordance with the present invention as depicted. The Camera 100 includes a camera frame that supports and houses the first lens 20 and second lens 30. The first lens 20 is a standard CMOS lens where the second lens, 30, is the spinning cylinder lens that provides the mapping of the light values. A CPU is provided for each particular lens as shown, a first lens CPU 25 and second lens CPU 35 under each respective lens. The CPU's are positioned beyond the outer edges of each lens. An outer edge 22 is shown for the first lens 20 and an outer edge 32 is shown for the second lens 30. Further shown in FIG. 1 is a rear Section 24 for the first lens, and a rear Section 34 for the second lens 30. An image is captured by each particular lens where the images are processed through an image layering CPU 40. This image layering CPU 40 weaves the images together to create the final image captured by the Camera 100. The Camera 100 includes a shutter release button 10 and a light meter 15.

FIG. 2 provides an overhead sectional view of the Camera 100. As shown in FIG. 2, the first Lens 20 may be on the left side and the second Lens 30 may be on the right side. A CMOS sensor 27 is provided for the first Lens 20 and a spinning cylinder 37 is provided for the second Lens 30. Further shown are the CPUs 25, 35 and the image layering CPU 40.

During operation the first lens captures the standard image that is processed by the first CPU 25. The second Lens 30 is a cylinder that spins to map the light values either from a single source or multiple sources, spreading them evenly over an entire frame. The second Lens 30 is synchronized with the first Lens 25 to capture the image at the same time. The user depresses the shutter release button halfway down to activate the focusing of the subject, the light sensor and activates the cylinder Lens 30 that begins spinning The RPM of the second Lens 30 is governed by the shutter speed or aperture. The longer the shutter speed remains open the more light is needed, therefore the quicker the cylinder Lens 30 spins. As soon as the shutter is closed both images are captured on separate photocell chips and then simultaneously travel to the image layering CPU 40. The image layering CPU 40 weaves the two images together where the cylinder image becomes the platform image that applies balance and proportional light onto the image. The CPU 40 calculates the areas that may be over and under exposed and then replaces it with appropriate values. The image from the cylinder Lens 30 is picked apart and the structural image captured by the first Lens 20 is built up. This process redistributes the existing light in each photo to provide optimized light balancing therefore providing a true image for the user. The present invention provides a camera with dual lenses using a standard CMOS and a spinning cylinder in the second lens to create an optimal image in low lighting and therefore negating the need for typical low lighting essentials such as a flash, tripod and high ISO values. The instant invention has been shown and described in what it considers to be the most practical and preferred embodiments. It is recognized, however, that departures may be made there from within the scope of the invention and that obvious modifications will occur to a person skilled in the art.

What is claimed is:

1. A duel lens camera for optimizing images comprising:
a. a first lens, where the first lens includes a CMOS sensor;
b. a second lens, where the second lens includes a spinning cylinder and said spinning cylinder spins the second lens to capture lighting values;
c. a first CPU, where the first CPU processes an image captured by the first lens;
d. a second CPU, where the second CPU process an image captured by the second lens; and
e. a image layering processor, where the image layering processor weaves the two images together where the cylinder image becomes the platform image that applies balance and proportional light onto the image.

2. The dual lens camera according to claim 1, further including at least a shutter release and a light meter.

3. The dual lens camera according to claim 1, where the second lens maps the light values either from a single source or multiple sources, spreading them evenly over an entire frame.

4. A method of digital photography comprising the steps of:
a. mounting first lens using CMOS sensor adjacent to a second lens with spinning cylinder;
b. synchronizing the first lens with the second lens to simultaneously capture an image;
c. depressing a shutter release button to about a 50% depression to activate focusing of the subject, the light sensor and activates the second lens that begins spinning;
d. fully depressing the shutter release to capture an image with both the first lens and the second lens;
e. storing each captured image on a photo cell associated with each respective lens; and
f. transferring each image to an image layering CPU, where the image layering CPU weaves the two images together where the image of the second lens becomes the platform image that applies balance and proportional light onto a final image.

5. The method according to claim 4, wherein spinning of the second lens increases in correlation to the shutter speed.

6. The method according to claim 4, where the imaging CPU calculates any areas that are over and under exposed and then replaces the areas with appropriate light values.

7. The method according to claim 4, where the image from the second lens is picked apart and the image captured by the first lens is built up.

8. The method according to claim 4 further comprising redistributing existing light in each image to provide optimized light balancing.
